(19) United States
(12) Patent Application Publication
(10) Pub. No.: US 2021/0370569 A1
(43) Pub. Date: Dec. 2, 2021

(54) METHOD FOR THE ONLINE SENSING OF THE RHEOLOGY OF THERMOPLASTIC AND/OR ELASTOMER MATERIAL FOR THE PRODUCTION OF INJECTION-MOULDED PARTS

(71) Applicant: Kloeckner Desma Elastomertechnik GmbH, Fridingen (DE)

(72) Inventor: Harald ZEBEDIN, Stockach (DE)

(73) Assignee: Kloeckner Desma Elastomertechnik GmbH, Fridingen (DE)

(21) Appl. No.: 17/253,786

(22) PCT Filed: Jun. 14, 2019
(86) PCT No.: PCT/EP2019/065673

§ 371 Date: Dec. 18, 2020

(30) Foreign Application Priority Data
Jun. 21, 2018 (DE) 10 2018 114 974.3

(51) Int. Cl. B29C 45/76; B29C 45/03; B29C 45/77; B29C 45/78; G01N 11/08

(52) U.S. Cl. CPC B29C 45/7646; B29C 45/03; B29C 45/77; B29C 45/78; G01N 2011/0026; B29C 2945/76006; B29C 2945/7605; B29C 2945/7604; G01N 11/08

(57) ABSTRACT

The invention relates to a method for the online sensing of the rheology of thermoplastic and/or elastomer material for the production of injection-molded parts, wherein a measuring tool (6) is arranged in an injection-molding machine (1) between the stationary clamping plate (2) and the movable clamping plate (3) thereof instead of a mold die, wherein the measuring tool (6) comprises a measuring channel (13), in the course of which at least two pressure sensors (16) and at least two temperature sensors (17) are arranged, which transfer corresponding measured values of the material injected by means of an injection assembly (5) into the measuring channel (13) to a programmable logic controller (PLC) belonging to the injection-molding machine (1), with these measured values being processed by means of an algorithm in the PLC, evaluated and made available for the actual injection process.

The invention relates to a method for the online sensing of the rheology of thermoplastic and/or elastomer material for the production of injection-molded parts, wherein a measuring tool is arranged in an injection-molding machine between the stationary clamping plate and the movable clamping plate thereof instead of a mold die, wherein the measuring tool comprises a measuring channel, in the course of which at least two pressure sensors and at least two temperature sensors are arranged. In addition, the invention relates to an injection-molding machine for carrying out the method.

As a basic concept, the viscosity of in particular raw rubber compounds, as well as other material-specific parameters, are to be determined during a pretreatment and under a shear that correspond to the conditions prevailing in the injection-molding process. To make this possible, the injection-molding machine is equipped with a setup that is similar in form containing a measuring channel with various sensors. In the slit, a defined flow process takes place, which is measured by the sensors. From the measured data, rheological characteristic values can be obtained.

It is in fact already known from an article by G. Ausias, C. Mobuchon, P. J. Carreau, M.-C. Heuzey, M. Sepehr, “Extensional properties of short glass fiber reinforced polypropylene”, Polymer Composites, 2005, 247, to test polypropylene material for its rheological properties by measuring the pressure drop in a measuring channel and by additionally measuring the corresponding temperatures, wherein between the stationary and movable clamping plates of an injection-molding machine an appropriate measuring tool was installed, into the measuring channel of which the polypropylene material was charged, the profile inside the channel was analyzed by pressure sensors and temperature sensors, and the material could exit at the opposite end of the channel. The measured data that were determined were evaluated in an external evaluation device (“LabVIEW Setup”).

It is therefore a disadvantage of this device that the determined data are not immediately available for the actual injection-molding operation for the production of injection-molded parts, and also, it is not ensured that elastomer materials can also be tested with the aid of this apparatus.

Crude rubber in particular is brought in its final form for processing (“ready mixed”) in a discontinuous method (typically an internal mixer). This and fluctuations in the raw material quality lead to high fluctuations in the properties of the raw material from batch to batch and in the molded parts produced therefrom, e.g. by elastomer injection molding. It has therefore always been a concern of processors to determine these property fluctuations and thence either to block a particular batch, to use it or to adapt it to the processing or secondary treatment steps.

Typically, the following methods are currently used for this purpose:

Vulcametry

Mooney viscometry / RPA measurement

Density test (not a rheologically relevant parameter)

IR spectroscopy (not a rheologically relevant parameter)

And less frequently:

Measuring kneader

(High-pressure) capillary viscometer (HPCV)

Defo test.

All these methods have the disadvantage that they do not characterize the flowability of the mixture, or they characterize it only inadequately with regard to the actual injection-molding process. The following reasons have been discussed in the literature:

Incorrect shear rate range

In injection molding the material is exposed to very high shear rates ranging from 100-10,00 1/s. Particularly in the range of less than 1000 1/s, and in the case of HPCV of more than 1000 1/s, the above-mentioned methods do not work with the standard method. The properties in the relevant range are therefore only partially measured.

Other pretreatment of the material (thermo-rheological history)

In the injection-molding machine, the material is plasticized and thus pre-sheared with the aid of the screw and at the same time is brought to a homogeneous processing temperature in the range of 80° C. The pre-shearing breaks up filler agglomerates, for example, and produces a homogeneous melt. This is not the case with the above-mentioned methods. The material is loaded cold and is not plasticized.

Test location and time

The investigation should be carried out as close as possible to the position of use (same environmental conditions) and at the time of processing. This is not generally the case in laboratory test as mentioned above. The batch is tested upon delivery, for example, and is then released for two months.

Shear heating In the methods in the higher shear rate range, the compound generally heats up in an uncontrolled manner to beyond the nominal temperature during the test. For this reason, no absolute measured values are obtained which can lead to large deviations when transferred to the injection-molding process.

Rheological special effects

A number of special effects of the rheology are relevant when rubber is processed by injection molding, but are not generally investigated in characterization. These include wall slip, entrance and outlet pressure drop /elastic effects /extensional flows, pressure dependence of viscosity.

High investment in equipment

The aforementioned pieces of laboratory testing equipment cost in the order of €100,000 each and thus represent a significant investment.

To overcome these disadvantages, a new measuring method for use in production is desirable. To this end, there have already been multiple discussions in the existing literature of the use of the processing injection-molding machine itself as a measuring instrument. With adaptations regarding the material flow path, sensors and evaluation, (most of) the above-mentioned disadvantages can be overcome. By using a suitable material transport path, very high shear rates of up to 10,000/s can be achieved. The pressure needed for this is typically available in the injection-molding machine. The pretreatment takes place exactly as it does in the actual processing, since the same injection unit and screw are used. The location is in production and the test time can be favorably chosen when production is actually starting up in manufacture. Rheological special effects correspond to the actual conditions found in the injection unit during processing, and no assumptions or transfers have to be made. The development of such a method is therefore desirable

According to the invention, a standard elastomer injection-molding machine is equipped with a set-up that is similar in form, containing a (rectangular) slit as a measuring channel with pressure and temperature sensors. In the slit a defined flow process takes place, which is measured by the sensors. From the measured data the rheological characteristic values can be obtained directly in the control system of the injection-molding machine (the so-called PLC). The material is plasticized in the injection unit of the machine and injected through the slit-like channel into free space.

The technology is intended to be used for carbon-based elastomers as well as solid and liquid silicone elastomers (ATV and LSR).

The measuring arrangement is used in production, but not during production. It replaces the production mold. A conversion is therefore always necessary.

The measuring principle is as follows: after plasticizing, material is fed via a suitable inlet into the slit capillary with a rectangular cross-section and is subject to purely viscous shear there. By two or more pressure sensors, which are installed flush in the slit wall, the pressure drop along the slit is measured. From the pressure drop and the geometry of the slit, the viscosity is calculated by analogy with the Hagen-Poiseuille law. The measuring principle corresponds in principle to that of a capillary viscometer.

Because the measured data from the pressure and temperature sensors are processed directly by the PLC belonging to the injection-molding machine, it is possible to dispense with the above-mentioned laboratory test equipment, which is considerably more expensive. The expensive components such as drive/pressure generation, control system and material feed system are already present in an injection-molding machine, and so only the measuring capability has to be retrofitted for a fraction of the price.

In the method according to the invention, the following measuring tool is employed:

It consists of two mounting plates, one of which is designated as an inlet plate and is fastened on the stationary clamping plate. A runner is provided in the stationary clamping plate, via which the injection assembly introduces the material to be tested into the measuring tool via an opening in the inlet plate. The opening in the inlet plate here is configured such that the round runner cross-section is converted to the rectangular cross-section of the measuring channel which is present in the measuring tool. In this case, to avoid dead spots and to ensure laminar flow, the cross-section of the opening in the inlet plate is widened to the slit width and then, while maintaining the same width, this is reduced to the appropriate slit height. The transitions here are configured to be uniform and rounded.

The rectangular measuring channel is accommodated in a housing, which is arranged between the two mounting plates and consists of a first two-part conically tapering inner part, forming the measuring channel, and an outer part which is complementary to the inner part and surrounds the inner part, wherein at least two pressure sensors and at least two temperature sensors are arranged in the inner part in such a way that at least the measuring diaphragms of the pressure sensors are flush with the inner wall of the measuring channel.

The outer housing part is configured to be cylindrical on the outside and has an opening on the inside, which tapers conically towards the fixed clamping plate. The recess on the inside corresponds to that of a truncated cone. The object of this element is to center the inner housing part. The measuring channel is arranged in this inner housing part. It possesses the outer shape of a truncated cone. It consists of two halves, which allow the measuring channel to be opened, e.g. for cleaning. Each half contains a side of the measuring channel divided according to its length, but slightly asymmetrically. On the pressure sensor side, the height of the measuring channel (e.g. 1.5 mm) is equal, while the opposite side is variable and has a height of either e.g. 0.5 mm (asymmetrical) or 1.5 mm (symmetrical). In one half of the inner housing part, for example three holes are introduced for mounting pressure sensors. The holes are disposed such that the measuring diaphragm of the pressure sensor is front flush with the channel wall. A step, which is located (e.g. approx. 5 mm) deeper in the hole, forms the sealing edge, and a thread further back on the wall allows the sensor to be fastened using a lock nut. On the outer circumference of the half truncated cone, some material has been removed above the hole to allow the measurement cables of the sensors to be fed to the outside. At the end of the measuring channel there is an opening into free space, into which the test material can escape and can then be removed manually. The insides of the half truncated cone are flat outside of the measuring slit to allow a smooth mutual connection to be made. The element is screwed on to the mounting plate (support plate) opposite the inlet plate and is not generally removed for cleaning owing to the sensitive cabling of the pressure sensors.

Opposite the pressure sensors in the other half of the half truncated cone forming the measuring channel, holes are provided to accommodate e.g. three temperature sensors. These are also introduced front flush with the measuring channel wall. This half truncated cone is screwed to the half truncated cone containing the pressure sensors but not to the support plate, to ensure stability during the measurement and to allow this half to be removed for cleaning.

The support plate is used for fastening the two half truncated cones on the movable clamping plate of the clamping unit. The two half truncated cones are thus aligned relative to one another. The half truncated cone of the pressure sensor side is sunk into an indentation for centering and is screwed to the support plate from the rear.

The overall set-up is fastened in the clamping plates of the injection-molding machine by way of the T-grooves and is centered by way of the nozzle point. The individual elements are centered relative to one another by way of tapered centering.

The heating is carried out on the one hand by way of the heating platens of the injection-molding machine, similarly to a molding tool; and on the other hand by way of a band heater, which is placed around the outer housing part to achieve the greatest possible homogeneity of temperature. The band heater is connected to an additional heating module of the injection-molding machine.

The signals from all necessary sensors are fed to the central machine control system (PLC) where they are evaluated. From the injection-molding machine itself, the stroke of the injection plunger is recorded. This is measured by way of a stroke measuring rod and is transferred to the machine control system by way of CAN bus. This takes place as for the normal operation of the injection-molding machine.

Pressure sensors that measure e.g. using the piezoelectric principle and transmit the signal via a wire (“single wire”) to a terminal on the surface of the measuring arrangement are used as the pressure sensors. Feedback to the sensor takes place via the measuring arrangement. From the interchange point on the surface of the arrangement, the signal is transmitted via a shielded cable to the measuring amplifier. The measuring amplifier is located either on a fairing plate of the clamping unit or in the machine switch cabinet. In the amplifier the signal is converted to a current signal and fed via simple cabling to an analogue input of the control system. There, the signal is digitized and made available to the control program. In the case of the temperature sensors the signal is fed, via a cable that is suitable for the thermocouple, directly to the control system, where it is registered on a corresponding analogue input and digitized.

Before a measurement, the measurement setup is assembled, screwed together and installed in the machine and connected. The injection unit and the setup are heated to a uniform measuring temperature, e.g. 80° C. The elastomer compound is fed to the injection unit as a strip and dosed and injected through the nozzle point into free space (not into the measuring setup) at least three times.

The injection unit is then moved up to the setup and a 500 ccm quantity, for example, is dosed. Injection is carried out at a constant, low injection speed through the measuring channel, while recording pressure, temperature and stroke, until
(a) the pressure measured in the measuring gap is constant or
(b) the volume has been used up, in which case the pressure change must be extrapolated to a constant final pressure (exponentially).
After waiting until the temperature in the measuring channel is once again within a range of 2° C. of the nominal temperature, a further 500 ccm is plasticized. The test is then repeated at a higher speed in order to obtain data at a higher shear rate. This is adjusted in ascending order for the shear rate range of interest (measuring points distributed logarithmically equally, typically five points per decade). The first measuring point is repeated at the end of the measuring series to test for drift or vulcanization (scorch). The test is then repeated at different temperatures.

The invention will be explained and illustrated below with the aid of drawings.

The figures show the following:

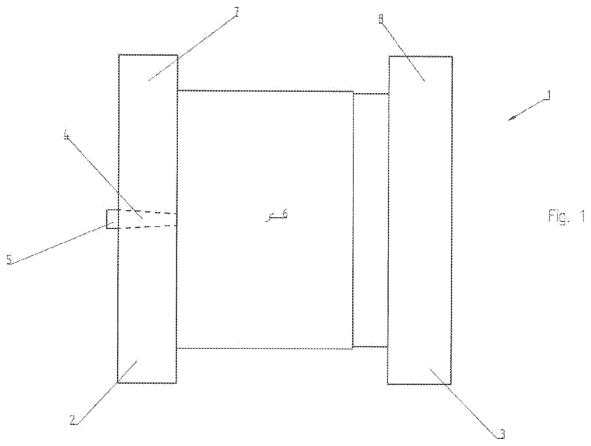

FIG. 1: schematic diagram of an injection-molding machine,

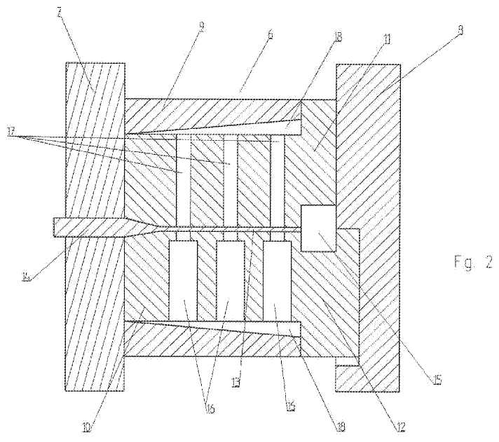

FIG. 2: measuring tool in section,

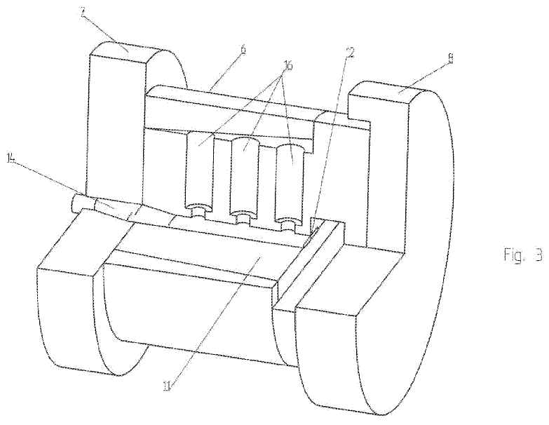

FIG. 3: perspective view of a cut-out of the measuring tool

FIG. 1 illustrates, in highly schematic form, the basic construction of a horizontally operating injection-molding machine, which is provided with the general reference numeral 1. The stationary clamping plate 2 is shown together with the movable clamping plate 3, which moves relative to this clamping plate 2. In the stationary clamping plate 2 a runner 4 is provided, in which the likewise schematically illustrated injection unit 5 fits. The clamping unit, which is responsible for the travelling movement of the movable clamping plate 3 and the build-up of clamping pressure, is not illustrated for reasons of clarity. Between the stationary clamping plate 2 and the movable clamping plate 3 a measuring tool is installed, which is referred to by the reference numeral 6 and is explained in more detail in FIGS. 2 and 3. The measuring tool 6 is arranged between the mounting plates 7 and 8, of which the mounting plate 7 is referred to as an inlet plate and the mounting plate 8 as a support plate.

In FIGS. 2 and 3, the measuring tool 6 is illustrated in more detail. The measuring tool 6 consists of two housing parts 9 and 10. The outer housing part 9 has an external cylindrical shape, while an opening exists on the inside which tapers conically towards the fixed clamping plate 2. This housing part 9 is mounted on the mounting plate 7. The two-part inner housing part 10, which is fastened on the mounting plate 8 and is configured in principle such that it is complementary to the housing part 9, is introduced into the conical opening of the housing part 9. Thus, the outer housing part 9 serves to center the housing part 10. The two parts of the housing part 10 are configured as truncated cone halves 11 and 12 and in the assembled state they enclose between them a measuring channel 13, which is rectangular in cross-section. The measuring channel 13 is connected via an opening 14 in the mounting plate 7 to the gate 4 in the fixed clamping plate 2. The measuring channel 13 leads into free space at its opposite end at 15.

In the truncated cone half 12, three pressure sensors 16 are installed one behind the other, their pressure measurement diaphragms being front flush with the measuring channel wall. In the truncated cone half 11, opposite the pressure sensors 16, temperature sensors 17 are installed which are also front flush with the measuring channel wall. On the outer circumference of each half truncated cone, some material has been removed above the holes accommodating the sensors in order to be able to feed the measurement cables of the sensors to the outside. These regions are provided with the reference numeral 18.

The opening 14 provided in the inlet plate 7 is configured such that it transitions from the round cross-section of the runner 4 to the rectangular cross-section of the measuring channel. The half truncated cone 12 accommodating the pressure sensors 16 is sunk into an indentation in the support plate 8 for centering purposes and is screwed to the support plate from the rear (not illustrated). The truncated cone half 11 is not fastened to the support plate 8 but is screwed to the truncated cone half 12, this being for reasons of stability and so that it can be removed more easily for cleaning the measuring channel 13.

1. A method for the online sensing of the rheology of thermoplastic and/or elastomer material for the production of injection-molded parts, wherein a measuring tool is arranged in an injection-molding machine between the stationary clamping plate and the movable clamping plate thereof instead of a mold die, wherein the measuring tool comprises a measuring channel, in the course of which at least two pressure sensors and at least two temperature sensors are arranged, which transfer corresponding measured values of the material injected by means of an injection assembly into the measuring channel to a programmable logic controller (PLC) belonging to the injection-molding machine, wherein these measured values are processed by means of an algorithm in the PLC, evaluated and made available for the actual injection process.

2. The method according to claim 1, wherein a slit capillary with a rectangular cross-section is provided as the measuring channel in the measuring tool.

3. The method according to claim 1, wherein in addition to the measurement of temperature and pressure, the mixing state and the wall slip behavior of the injected material are also determined.

4. An injection-molding machine for carrying out the method according to claim 1, having an injection assembly, a stationary clamping plate, a movable clamping plate and a mold clamping device, wherein a measuring tool is arranged between the stationary clamping plate and the movable clamping plate, said measuring tool having a measuring channel that can be supplied with thermoplastic and/or elastomer material by the injection assembly via a runner in the stationary clamping plate, wherein the measuring channel is configured such that it is open at its end opposite the injection assembly,
wherein the measuring channel is surrounded by a housing, which is arranged between two mounting plates and comprises a first two-part conically tapering inner part forming the measuring channel and an outer part that is complementary to the inner part and encloses the inner part, wherein at least two pressure sensors and at least two temperature sensors are arranged in the inner part in such a way that at least the measuring diaphragms of the pressure sensors are flush with the inner wall of the measuring channel.

5. The injection-molding machine according to claim 4, wherein the measuring channel is formed as a slit capillary with a rectangular cross-section.

6. The injection-molding machine according to claim 4, wherein the dividing line between the two parts of the first conically tapering inner part of the housing runs along the measuring channel.

7. The injection-molding machine according to claim 4, wherein the transition from the runner into the measuring channel is formed in the corresponding mounting plate in a flow-optimized manner.

8. The injection-molding machine according to claim 4, wherein the pressure sensors are arranged opposite the temperature sensors.

9. The injection-molding machine according to claim 4, wherein the inner part of the housing is mounted on the mounting plate that is fastened on the movable clamping plate, and the outer housing part is mounted on the mounting plate that is connected to the stationary clamping plate.
